(19) United States
(12) Patent Application Publication
(10) Pub. No.: US 2015/0273813 A1
(43) Pub. Date: Oct. 1, 2015

(54) FIBER-REINFORCED RESIN PLATE PUNCHING METHOD AND FIBER-REINFORCED RESIN PRODUCT FABRICATION METHOD

(71) Applicant: NHK SPRING CO., LTD., Yokohama-shi (JP)

(72) Inventor: Kenzo Yasuda, Yokohama-shi (JP)

(21) Appl. No.: 14/659,468

(22) Filed: Mar. 16, 2015

(30) Foreign Application Priority Data
Mar. 25, 2014 (JP) 2014-062568

(51) Int. Cl. B32B 38/04; B26D 7/10

(52) U.S. Cl. CPC B32B 38/04; B26D 7/10; B32B 2038/042; B32B 2305/10

(57) ABSTRACT

There is provided a method of punching a fiber-reinforced resin plate, the method including: heating a fiber-reinforced resin plate, that is formed in a plate shape and is formed with a thermoplastic resin impregnated into a reinforcing fiber fabric, with a pre-heating section such that a surface temperature of the fiber-reinforced resin plate is at least a glass transition temperature of the thermoplastic resin; and punching the heated fiber-reinforced resin plate to a predetermined external shape with a punching section that is provided with a Thomson blade.

### CROSS-REFERENCE TO RELATED APPLICATION

This application is based on and claims priority under 35 USC 119 from Japanese Patent Application No. 2014-062568 filed on Mar. 25, 2014, the disclosure of which is incorporated by reference herein.

### BACKGROUND

1. Technical Field

The present invention relates to a fiber-reinforced resin plate punching method and a fiber-reinforced resin product fabrication method.

2. Related Art

Japanese Patent Application Laid-Open (JP-A) No. 2011-84038 discloses a method of fabricating a fiber-reinforced resin product in which a fiber-reinforced resin plate is shaped and punched. Specifically, this is a method that fabricates the fiber-reinforced resin product through: a step of pre-heating the fiber-reinforced resin plate; and a step of shaping and punching the pre-heated fiber-reinforced resin plate with a mold that is structured by a forming die and a press die. The temperature of the mold itself can be adjusted by a built-in heater in the mold or the like. Thus, shaping of the fiber-reinforced resin plate may be facilitated by warming of the mold. The punching of the fiber-reinforced resin plate may be conducted by the press die provided in the mold. Thus, the fiber-reinforced resin plate may be shaped and punched in a single step.

In a case according to the conventional technology described above, the forming die for shaping the fiber-reinforced resin plate is included in the mold. Moreover, the structure enables temperature adjustment of the mold itself by the built-in heater or the like. Therefore, the structure of the mold is complex. In addition, because burrs occur at cut faces after punching with the press die, a step to remove burrs is necessary. Therefore, even if the fiber-reinforced resin plate is only punched without being shaped, fabrication costs may not be reduced.

### SUMMARY

In consideration of the circumstances described above, an object of the present invention is to provide a fiber-reinforced resin plate punching method and a fiber-reinforced resin product fabrication method that may reduce fabrication costs.

A first aspect of the present invention provides a method of punching a fiber-reinforced resin plate, the method including:

heating a fiber-reinforced resin plate, that is formed in a plate shape and is formed with a thermoplastic resin impregnated into a reinforcing fiber fabric, with a pre-heating section such that a surface temperature of the fiber-reinforced resin plate is at least a glass transition temperature of the thermoplastic resin (first step); and

punching the heated fiber-reinforced resin plate to a predetermined external shape with a punching section that is provided with a Thomson blade (second step).

A second aspect of the present invention provides the method according to the first aspect, wherein the reinforcing fiber fabric of the fiber-reinforced resin plate includes continuous fibers rather than short fibers.

A third aspect of the present invention provides the method according to the first or second aspects, wherein the reinforcing fiber fabric of the fiber-reinforced resin plate includes glass fibers.

A fourth aspect of the present invention provides the method according to any one of the first through third aspects, wherein the thermoplastic resin of the fiber-reinforced resin plate is a polyamide-based thermoplastic resin.

A fifth aspect of the present invention provides the method according to any one of the first through fourth aspects, wherein a plate thickness of the fiber-reinforced resin plate is at most 2.0 mm.

A sixth aspect of the present invention provides a method of fabricating a fiber-reinforced resin product, the method including:

heating a fiber-reinforced resin plate, that is formed in a plate shape and is formed with a thermoplastic resin impregnated into a reinforcing fiber fabric, with a pre-heating section such that a surface temperature of the fiber-reinforced resin plate is at least a glass transition temperature of the thermoplastic resin (first step); and

punching the heated fiber-reinforced resin plate to a predetermined external shape with a punching section that is provided with a Thomson blade (second step).

According to the first aspect of the present invention, in the first step, the fiber-reinforced resin plate that is formed with the thermoplastic resin impregnated into the reinforcing fiber fabric is heated to at least the glass transition temperature of the thermoplastic resin by the pre-heating section. Thus, the fiber-reinforced resin plate is softened. Then, in the second step, the softened fiber-reinforced resin plate is punched to the predetermined external shape, that is, the external shape of a fiber-reinforced resin product, by the punching section. Thus, a plate-shaped fiber-reinforced resin product may be obtained. In this step of punching, because the fiber-reinforced resin plate is punched in a state of having been softened by heating by the pre-heating section, a load on the punching section is reduced. Therefore, the structure of the punching section may be a simple structure equipped with a Thomson blade and, at the same time, durability of the Thomson blade may be improved.

Further, because the fiber-reinforced resin plate is punched by the punching section in the state of having been softened by the pre-heating section, shear stresses applied to the fiber-reinforced resin plate are smaller than in a case in which a fiber-reinforced resin plate is punched while cold. Therefore, deformation or the like of the fiber-reinforced resin plate itself at the time of punching may be suppressed.

Because the fiber-reinforced resin product with the predetermined external shape is formed from the fiber-reinforced resin plate by the punching section equipped with the Thomson blade, occurrences of burrs may be suppressed. Moreover, a duration for machining may be shortened compared to water-jet machining, laser machining or the like that cuts a fiber-reinforced resin plate along the outline of the predetermined external shape.

According to the second aspect of the present invention, the reinforcing fiber fabric of the fiber-reinforced resin plate is constituted with continuous fibers rather than short fibers. Therefore, the strength is higher than in a fiber-reinforced resin constituted with short fibers. In the present invention, because the fiber-reinforced resin plate is heated by the pre-heating section and softened, the punching may still be performed by a simple punching section.

According to the third aspect of the present invention, the fiber-reinforced resin plate is constituted with glass fibers. Therefore, the cost of the material itself may be suppressed and the strength may be improved. In addition, because the punching method of the present invention reduces a load on the punching section, the structure of the punching section may be a simple structure that is structured with a Thomson blade. Therefore, when a fiber-reinforced resin plate is punched by the punching method of the present invention, both material costs may be suppressed and fabrication costs may be suppressed.

Polyamide-based thermoplastic resins have high water absorbency and dimensions thereof are altered by water absorption. According to the fourth aspect of the present invention, because there is no machining that uses water, such as water jet machining, a fiber-reinforced resin plate that is constituted with a polyamide-based thermoplastic resin may be punched with deformation thereof being suppressed.

According to the fifth aspect of the present invention, there is no need for a pre-punching step that forms cuts (incisions) or the like along the outline of the predetermined external shape before the step of punching. Therefore, the punching itself only takes one step and working steps may be reduced.

According to the sixth aspect of the present invention, similarly to the first aspect, the structure of the punching section may be made simple, in addition to which deformation and the like of the fiber-reinforced resin plate itself at the time of punching may be suppressed. Moreover, the duration of machining may be shortened compared to water-jet machining, laser machining or the like.

The fiber-reinforced resin plate punching method according to the first aspect of the present invention has an excellent effect in that fabrication costs may be reduced.

The fiber-reinforced resin plate punching method according to the second aspect of the present invention has an excellent effect in that fabrication costs may be reduced even in a case of machining a fiber-reinforced resin product from a fiber-reinforced resin plate that is constituted with continuous fibers.

The fiber-reinforced resin plate punching method according to the third aspect of the present invention has an excellent effect in that overall fabrication costs including material costs may be suppressed.

The fiber-reinforced resin plate punching method according to the fourth aspect of the present invention has an excellent effect in that the product quality of punched products may be made consistent.

The fiber-reinforced resin plate punching method according to the fifth aspect of the present invention has an excellent effect in that a machining duration may be shortened.

The fiber-reinforced resin product fabrication method according to the sixth aspect of the present invention has an excellent effect in that fabrication costs may be reduced.

### BRIEF DESCRIPTION OF THE DRAWINGS

Exemplary embodiments of the present invention will be described in detail based on the following figures, wherein:

FIG. 1 is a perspective view of a punching die for a fiber-reinforced resin plate punching method and a fiber-reinforced resin product fabrication method in accordance with an exemplary embodiment;

FIG. 2A is a perspective view schematically showing a step of pre-heating in the fiber-reinforced resin plate punching method and fiber-reinforced resin product fabrication method in accordance with the exemplary embodiment;

FIG. 2B is a perspective view schematically showing a fiber-reinforced resin plate pre-heated in FIG. 2A in a state before punching with the punching die;

FIG. 2C is a perspective view corresponding to FIG. 2B, schematically showing the fiber-reinforced resin plate in a state after punching with the punching die;

FIG. 3A is an enlarged sectional diagram showing the fiber-reinforced resin plate and the punching die before the punching of the fiber-reinforced resin plate punching method and fiber-reinforced resin product fabrication method in accordance with the exemplary embodiment;

FIG. 3B is an enlarged sectional diagram corresponding to FIG. 3A, showing the fiber-reinforced resin plate and the punching die during the punching;

FIG. 3C is an enlarged sectional diagram corresponding to FIG. 3B, showing the fiber-reinforced resin plate and the punching die after the punching;

FIG. 4 is a perspective diagram of the fiber-reinforced resin plate of the fiber-reinforced resin plate punching method and fiber-reinforced resin product fabrication method in accordance with the exemplary embodiment;

FIG. 5A is an enlarged sectional diagram showing a fiber-reinforced resin plate, a forming die and a punching die before punching in a fiber-reinforced resin plate punching method and a fiber-reinforced resin product fabrication method in accordance with a comparative example;

FIG. 5B is an enlarged sectional diagram corresponding to FIG. 5A, showing a state in which shaping has been applied to the fiber-reinforced resin plate;

FIG. 5C is an enlarged sectional diagram corresponding to FIG. 5B, showing a state in which punching has been performed;

FIG. 6A is an enlarged sectional diagram showing a portion of the fiber-reinforced resin plate and the punching die before the punching in the fiber-reinforced resin plate punching method and fiber-reinforced resin product fabrication method in accordance with the comparative example;

FIG. 6B is an enlarged sectional diagram corresponding to FIG. 6A, showing a state during the punching; and

FIG. 6C is an enlarged sectional diagram corresponding to FIG. 6B, showing a state after the punching.

### DETAILED DESCRIPTION

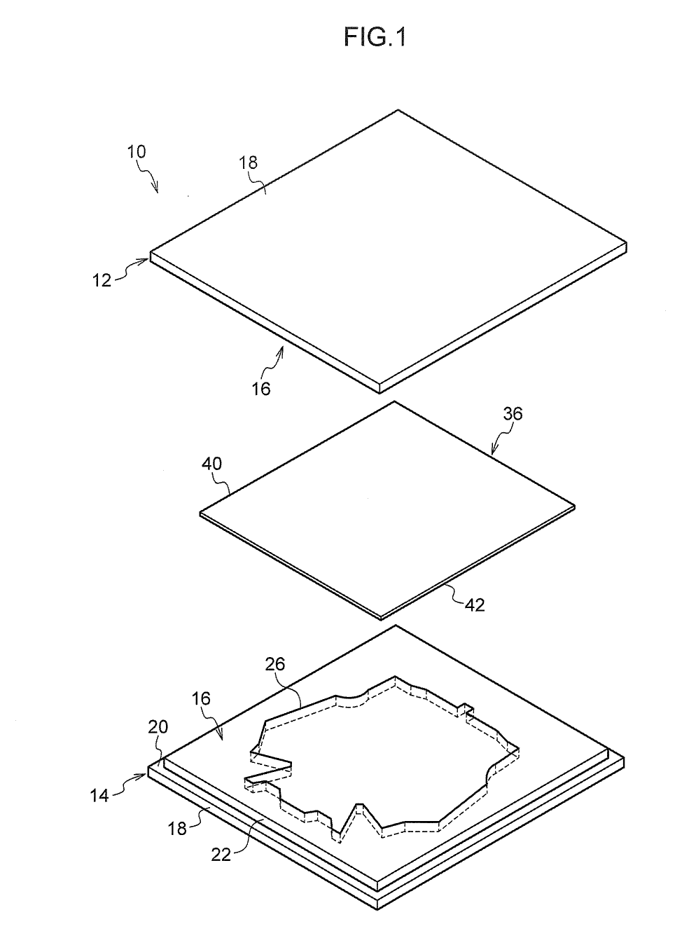

Herebelow, an exemplary embodiment of the fiber-reinforced resin plate punching method and fiber-reinforced resin product fabrication method according to the present invention is described using FIG. 1 to FIG. 4.

FIG. 1 shows a punching die 10, which serves as a punching section. The punching die 10 is structured by an upper die 12 and a lower die 14, which are respectively disposed such that inner side faces 16 thereof oppose one another.

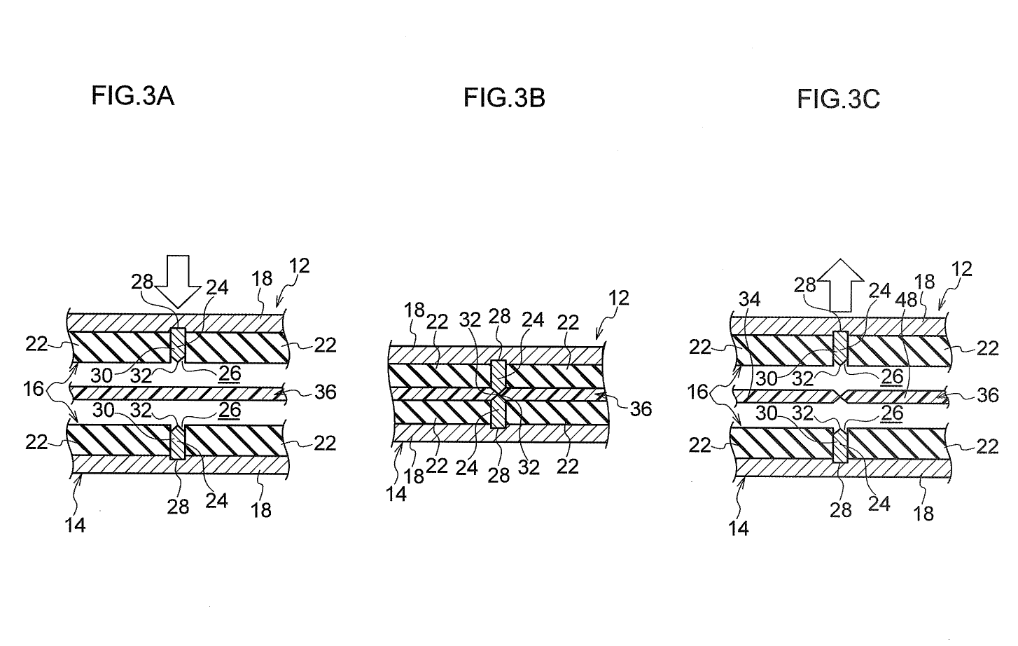

The lower die 14 includes a base plate 18 and a stripper plate 22. The base plate 18 is formed in a rectangular shape in plan view and is structured by a wooden plate. The stripper plate 22 is attached to an upper face 20 of the base plate 18. The stripper plate 22 is formed in a similar shape to the base plate 18 in plan view, smaller than the base plate 18. The stripper plate 22 is constituted of, for example, silicone rubber. As shown in FIG. 3A, a notch groove 26 is formed in the stripper plate 22. The notch groove 26 is cut in the plate thickness direction at locations at which a Thomson blade 24, which is described below, is to be provided. The base plate 18 and the stripper plate 22 may be constituted of alternative materials.

The Thomson blade 24 is attached to the base plate 18. A cross-section of the Thomson blade 24 has a substantially rectangular shape. One length direction end portion 28 of the cross section of the Thomson blade 24 is embedded in the base plate 18. A blade portion 32 is formed at another end portion 30 at the opposite end in the length direction of the cross section of the Thomson blade 24 from the end at which the end portion 28 is disposed. At the blade portion 32, a substantially central portion in a short direction of the cross section protrudes to the opposite side from the side thereof at which the base plate 18 is disposed. The blade portion 32 of the Thomson blade 24 is formed to be a continuous shape along an external shape of a fiber-reinforced resin product 34, which is described below.

The upper die 12 has a similar structure to the lower die 14; that is, the stripper plate 22 and the Thomson blade 24 are attached to the base plate 18. The upper die 12 is mounted at a press machine, which is not shown in the drawings, such that the blade portion 32 of the Thomson blade 24 of the upper die 12 and the blade portion 32 of the Thomson blade 24 of the lower die 14 oppose one another. Thus, the respective blade portions 32 of the Thomson blades 24 of the upper die 12 and the lower die 14 may be moved close to and away from one another by the press machine. In other words, the punching die 10 has a two-blade structure.

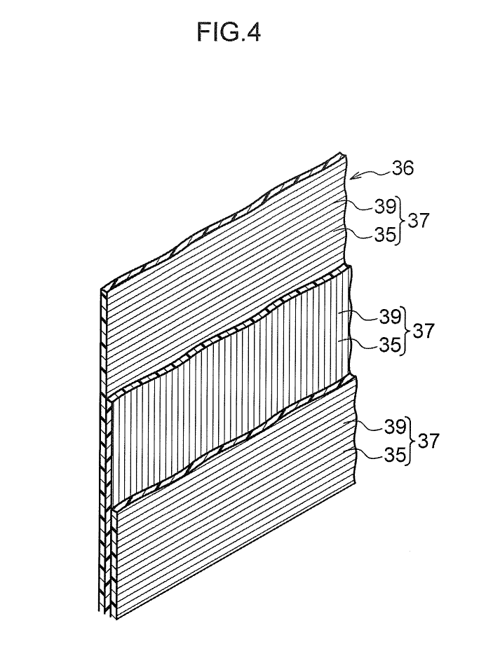

A fiber-reinforced resin plate 36 may be set between the upper die 12 and the lower die 14. As shown in FIG. 4, the fiber-reinforced resin plate 36 has a structure in which sheets 37 are plurally laminated. In each sheet 37, a thermoplastic resin 39 that serves as a matrix resin is impregnated into continuous fibers 35 that serve as a reinforcing fiber fabric and then hardened. The continuous fibers 35 are a fabric constituted of glass fibers, or a unidirectional material or the like. Each sheet 37 is strong with respect to tension in the direction of the continuous fibers 35 but weak with respect to tension in a direction orthogonal to the direction of the continuous fibers 35. Accordingly, the strength of the fiber-reinforced resin plate 36 with respect to tensions from various directions is assured by the plural sheets 37 being laminated such that the fiber directions thereof are different. In the present exemplary embodiment, the thermoplastic resin 39 is constituted of a polyamide-based thermoplastic resin, for example, PA6.

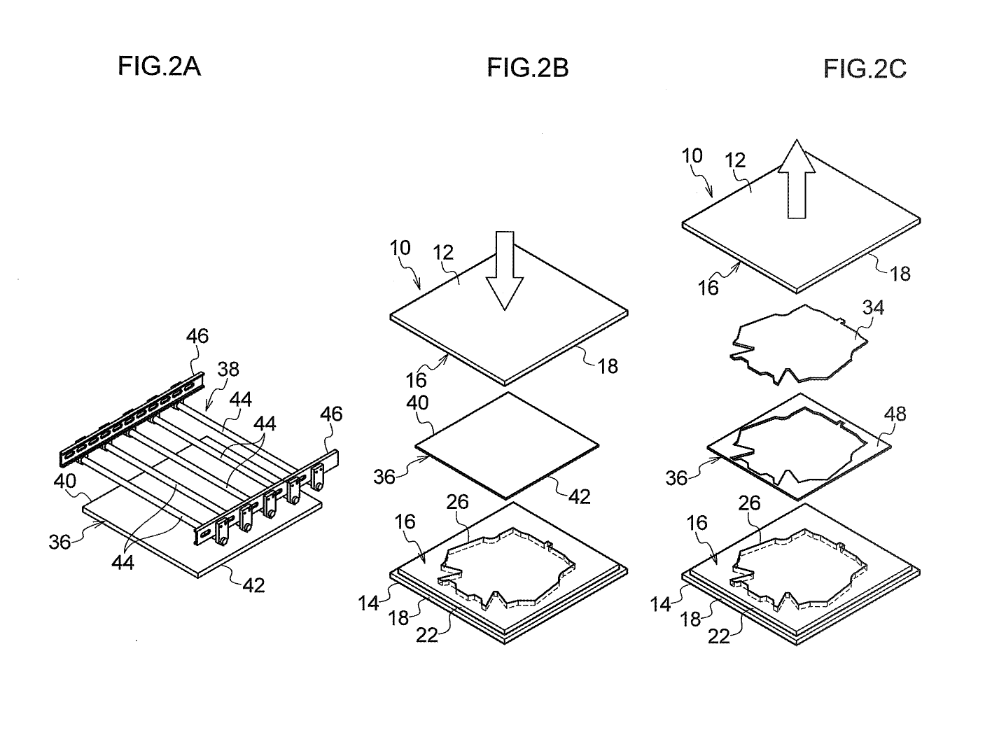

Now, the fiber-reinforced resin plate punching method and fiber-reinforced resin product fabrication method are described using FIG. 2A to FIG. 2C and FIG. 3A to FIG. 3C.

As shown in FIG. 2A, the fiber-reinforced resin plate 36 is heated by an infrared heater 38 that serves as a pre-heating section. The infrared heater 38 includes a plural number of heating lines 44 that are formed in circular rod shapes, extending from one end portion 40 of the fiber-reinforced resin plate 36 to another end portion 42 at the opposite end from the one end portion 40, and that emit heat when electrified. The plural heating lines 44 are attached to retainers 46 that retain the heating lines 44 in a substantially horizontal direction at a predetermined spacing. The fiber-reinforced resin plate 36 is conveyed below the infrared heater 38 by a conveyance section, which is not shown in the drawings. Having been disposed below the infrared heater 38, the fiber-reinforced resin plate 36 is retained and is heated. During this heating, a surface temperature of the fiber-reinforced resin plate 36 is heated to at least the glass transition temperature of the thermoplastic resin. In the present exemplary embodiment, the surface temperature of the fiber-reinforced resin plate 36 is heated to at least 46° C., the glass transition temperature of PA6. This step corresponds to the “first step” in the first aspect of the invention.

As shown in FIG. 2B and FIG. 3A, the fiber-reinforced resin plate 36 that has been heated in the first step is conveyed between the upper die 12 and lower die 14 of the punching die 10. When the fiber-reinforced resin plate 36 is set between the upper die 12 and the lower die 14, the blade portion 32 of the Thomson blade 24 of the upper die 12 is moved to the lower side in the vertical direction by the press machine so as to come close to the blade portion 32 of the Thomson blade 24 of the lower die 14, as shown in FIG. 3B. As a result, the fiber-reinforced resin plate 36 comes close to the respective stripper plates 22 of the upper die 12 and the lower die 14, and the respective stripper plates 22 of the upper die 12 and the lower die 14 are compressed in the plate thickness direction. Accordingly, the blade portion 32 of the Thomson blade 24 of the upper die 12 and the blade portion 32 of the Thomson blade 24 of the lower die 14 bite into the fiber-reinforced resin plate 36. When the blade portion 32 of the Thomson blade 24 of the upper die 12 and the blade portion 32 of the Thomson blade 24 of the lower die 14 come close together, the fiber-reinforced resin plate 36 is divided into the fiber-reinforced resin product 34, which has a predetermined external shape, and a waste portion 48. Thereafter, when the upper die 12 is moved to the upper side in the vertical direction so as to move away from the lower die 14, as shown in FIG. 2C and FIG. 3C, the stripper plate 22 of the upper die 12 and the stripper plate 22 of the lower die 14 that have been compressively deformed in the plate thickness direction return to their original shapes (plate thicknesses). The fiber-reinforced resin plate 36 is released from the blade portion 32 of the Thomson blade 24 of the upper die 12 and the blade portion 32 of the Thomson blade 24 of the lower die 14 that have bitten into the fiber-reinforced resin plate 36 by this restoring force. Thus, the fiber-reinforced resin plate 36 is released from the punching die 10. Thereafter, the fiber-reinforced resin product 34 and waste portion 48 of the fiber-reinforced resin plate 36 are separated when they are extracted from the punching die 10. Thus, the punching is complete. This step corresponds to the “second step” in the first aspect of the invention. By the steps described above, the fiber-reinforced resin product 34 is fabricated.

Now, operation and effects of the present exemplary embodiment are described.

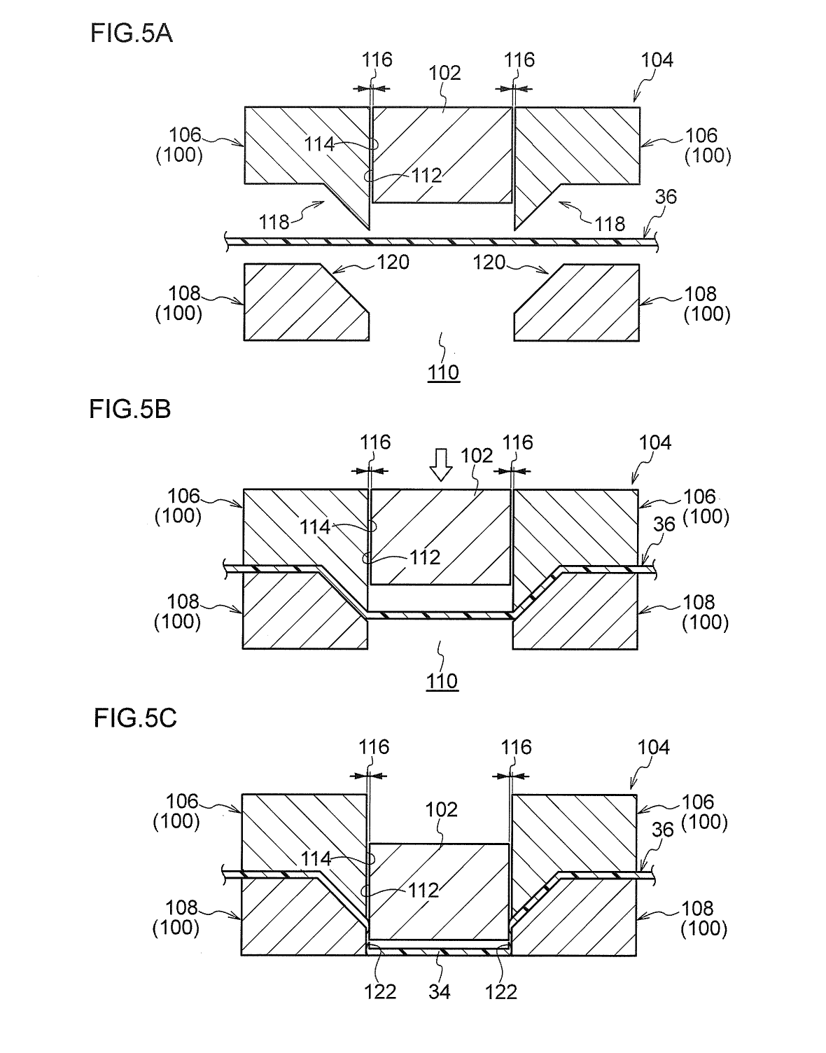

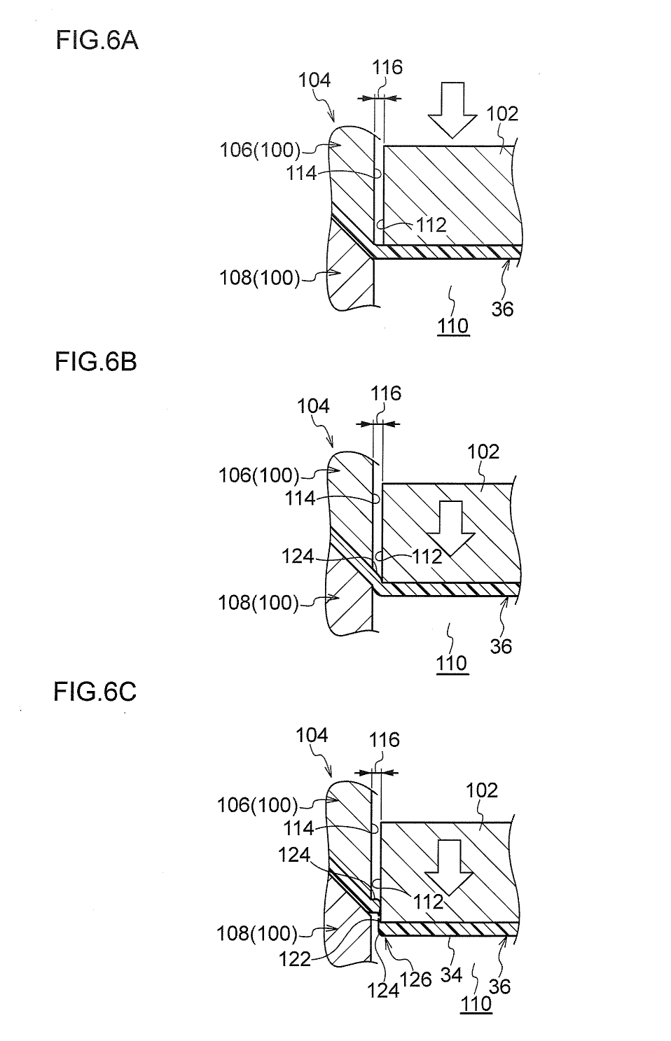

The operation and effects of the present exemplary embodiment are described using a comparative example illustrated in FIG. 5A to FIG. 5C and FIG. 6A to FIG. 6C. In this comparative example, structural elements that are the same as in the exemplary embodiment are assigned the same reference numerals and are not described.

The comparative example includes a step of pre-heating the fiber-reinforced resin plate 36 and a step of shaping and punching the pre-heated fiber-reinforced resin plate 36 with a mold 104 that is structured by a forming die 100 and a press die 102. The temperature of the mold 104 itself can be adjusted by a built-in heater or the like, which is not shown in the drawings, in the mold 104. Thus, the shaping and punching of the fiber-reinforced resin plate 36 are carried out in a single step.

As shown in FIG. 5A, the mold 104 is structured by an upper die 106 and a lower die 108. The built-in heater is incorporated in each of the upper die 106 and lower die 108. The upper die 106 and lower die 108 are mounted at a press machine, which is not shown in the drawings, with a structure in which the upper die 106 can be moved in a vertical direction by the press machine. A recess portion 110 with substantially the same shape as the external shape of the fiber-reinforced resin product 34 is formed in the lower die 108. The press die 102, whose external shape is substantially the same as the external shape of the fiber-reinforced resin product 34, is provided at the upper die 106. The press die 102 can be lowered into the recess portion 110 of the lower die 108. When the press die 102 is lowered into the recess portion 110 of the lower die 108, a clearance 116 is provided between end portions 112 of the press die 102 and end portions 114 of the recess portion 110.

When the fiber-reinforced resin product 34 is to be formed, the fiber-reinforced resin plate 36 that has been pre-heated by the infrared heater 38 is conveyed to between a lower face 118 of the upper die 106 and an upper face 120 of the lower die 108. Then, as shown in FIG. 5B, in the state in which the fiber-reinforced resin plate 36 is disposed between the lower face 118 of the upper die 106 and the upper face 120 of the lower die 108, the upper die 106 that has already been heated by its built-in heater is lowered toward the lower die 108 that, similarly to the upper die 106, has been heated by its built-in heater. Thus, the fiber-reinforced resin plate 36 is shaped. As shown in FIG. 5C, shear stresses are applied to the fiber-reinforced resin plate 36 by the press die 102 being lowered into the recess portion 110 of the lower die 108 (see FIG. 6A). At this time, a shear drop 124 is produced at the fiber-reinforced resin plate 36 in the clearance 116 (see FIG. 6B).

When the press die 102 is lowered further, cracks are formed in the fiber-reinforced resin plate 36 from locations that abut against the end portions 112 of the press die 102 and locations that abut against the end portions 114 of the recess portion 110 of the lower die 108. Then, as shown in FIG. 6C, the cracks become shear faces and the fiber-reinforced resin product 34 is punched from the fiber-reinforced resin plate 36. At this time, burrs 122 are formed at end portions 126 of the fiber-reinforced resin product 34.

That is, according to the comparative example described above, the mold 104 includes the forming die 100 for the shaping of the fiber-reinforced resin plate 36, and is a structure in which the mold 104 itself is heated by the built-in heaters and shapes the fiber-reinforced resin plate 36. Therefore, the structure of the mold 104 is complex. Further, because the burrs 122 occur at the shear faces punched by the press die 102, a step to remove the burrs 122 is required. Moreover, because the shear drop 124 is produced at the fiber-reinforced resin plate 36, dimensional precision of the fiber-reinforced resin product 34 deteriorates.

If punching alone is performed without shaping, the forming die 100 is unnecessary. However, a holding portion that holds the fiber-reinforced resin plate 36 while the fiber-reinforced resin plate 36 is being punched by the press die 102 is necessary. Therefore, because the mold structure is equipped with the holding portion and because the waste portion 48 of the fiber-reinforced resin plate 36 is necessary to some extent for holding by the holding portion, yield may not be improved. Therefore, fabrication costs may not be reduced even if the fiber-reinforced resin plate 36 is only punched.

Beside punching, the fiber-reinforced resin product 34 with the predetermined external shape may also be obtained from the fiber-reinforced resin plate 36 by water-jet machining, laser machining or the like. However, these are machining methods that cut the fiber-reinforced resin plate 36 by tracing a single line along the outline of the predetermined external shape. Therefore, time is required for the cutting machining, and the machining duration varies depending on the periphery of the external shape. Moreover, in a case in which the fiber-reinforced resin plate 36 is constituted with a thermoplastic resin 39 that features water absorbency, such as a polyamide or the like, if machining to cut the predetermined shape is performed by water jet machining, then water of the water jet machining comes into contact with the thermoplastic resin 39. Therefore, the fiber-reinforced resin plate 36 may absorb water, swell and deform. Hence, there may be problems with dimensional consistency of the fiber-reinforced resin product 34. Furthermore, abrasive grains that are used in water jet machining to improve cutting performance must be dealt with. Therefore, fabrication costs may not be reduced.

In a case of laser machining, the fiber-reinforced resin plate 36 is heated by a laser illuminated at high energy, and burrs may occur when the fiber-reinforced resin plate 36 solidifies after melting. Therefore, a step to remove these burrs is necessary, and fabrication costs may be not be reduced.

However, according to the fiber-reinforced resin product 34 fabrication method and the fiber-reinforced resin plate 36 punching method in accordance with the present exemplary embodiment, as shown in FIG. 2A to FIG. 2C, the fiber-reinforced resin plate 36 that is formed with the thermoplastic resin 39 having been impregnated into the continuous fibers 35 is heated to at least the glass transition temperature of the PA6 by the infrared heater 38 in the first step. Thus, the fiber-reinforced resin plate 36 is softened. Then, in the second step, the fiber-reinforced resin plate 36 is punched to the predetermined external shape, that is, the external shape of the fiber-reinforced resin product 34, by the punching die 10. Thus, the plate-shaped fiber-reinforced resin product 34 may be obtained. In this step of punching, because the fiber-reinforced resin plate 36 is punched in a state of having been softened by heating by the infrared heater 38, a load on the Thomson blades 24 is reduced. Therefore, the structure of the punching die 10 may be a simple structure equipped with the Thomson blades 24 and, at the same time, durability of the Thomson blades 24 may be improved. Thus, fabrication costs may be reduced.

Because the fiber-reinforced resin plate 36 is punched by the punching die 10 in the state of having been softened by the infrared heater 38, shear stresses applied to the fiber-reinforced resin plate 36 are smaller than in a case in which the fiber-reinforced resin plate 36 is punched while cold. Therefore, deformation or the like of the fiber-reinforced resin plate 36 itself may be suppressed. Thus, product quality of the fiber-reinforced resin product 34 may be made consistent. Moreover, because shear stress forces are small, there is no need for holding of the fiber-reinforced resin plate 36 at the time of punching. Therefore, because there is no need for a holding portion at the punching die 10, the structure of the punching die 10 may be made simpler. In addition, because there is no need for the waste portion 48 to be held by a holding portion, yield of the fiber-reinforced resin plate 36 may be improved. Thus, fabrication costs may be reduced in a case in which only punching of the fiber-reinforced resin plate 36 is performed.

Because the fiber-reinforced resin product 34 with the predetermined external shape is formed from the fiber-reinforced resin plate 36 by the punching die 10 equipped with the Thomson blades 24, occurrences of the burrs 122 may be suppressed. Moreover, a duration for machining may be shortened compared to water jet machining, laser machining or the like that cuts the fiber-reinforced resin plate 36 along the outline of the predetermined external shape. Thus, fabrication costs may be further reduced.

The reinforcing fiber fabric of the fiber-reinforced resin plate is constituted with continuous fibers rather than short fibers. Therefore, the strength is higher than in a fiber-reinforced resin constituted with short fibers. Accordingly, punching machining of the fiber-reinforced resin plate 36 constituted with the continuous fibers 35 would ordinarily be difficult. However, in the present invention, because the fiber-reinforced resin plate 36 is heated by the infrared heater 38 and softened, the punching may be performed by a simple punching section. Thus, fabrication costs may be reduced even when machining the fiber-reinforced resin product 34 from the fiber-reinforced resin plate 36 that is constituted with the continuous fibers 35.

Because the punching die 10 is a structure that is equipped with the Thomson blades 24, the following effect may also be provided. Because the fiber-reinforced resin plate 36 is punched by the blade portions 32 of the Thomson blades 24, occurrences of burrs at the shear faces of the fiber-reinforced resin product 34 may be suppressed. Therefore, a step to remove the burrs 122 is not necessary. Moreover, because shear drop is not produced at the fiber-reinforced resin plate 36, a deterioration in dimensional precision of the fiber-reinforced resin product 34 may be suppressed.

Because the fiber-reinforced resin plate 36 is constituted with glass fibers, the cost of the material itself may be suppressed and the strength may be improved. In addition, because the punching method of the present invention reduces a load on the punching die 10, the structure of the punching die 10 may be a simple structure that is structured with the Thomson blades 24. Therefore, when the fiber-reinforced resin plate 36 is punched by the punching method of the present invention, both material costs may be suppressed and fabrication costs may be suppressed. Thus, overall fabrication costs including material costs may be suppressed.

Because there is no machining that uses water, such as water jet machining, the fiber-reinforced resin plate 36 that is constituted with the polyamide-based thermoplastic resin 39, which has high water absorbency and whose dimensions are altered by water absorption, may be punched with deformation thereof being suppressed. Thus, the product quality of the fiber-reinforced resin product 34 may be made consistent.

Because there is no need for a pre-punching step to form cuts (incisions) or the like along the outline of the predetermined external shape to make punching easier before the step of punching, the punching itself only takes one step and working steps may be reduced. Thus, the machining duration may be shortened.

### Examples

Herebelow, the present invention is described more specifically in accordance with Examples. Note that the present invention is not limited by these Examples.

—Punching Performance in Accordance with the Pre-Heating Temperature—

Each fiber-reinforced resin plate 36 was pre-heated to a temperature shown in the below Table 1 before punching of the fiber-reinforced resin plate 36, and the punching performance was evaluated. The results are shown below in Table 1. In Table 1, A (good) indicates that punching was possible, B (medium) indicates that punching performance was poor but punching was possible, and C (bad) indicates that punching was not possible.

The punching die 10 had a two-blade structure provided with the Thomson blades 24 at the upper die 12 and the lower die 14. A clearance between the blade portion 32 of the Thomson blade 24 of the upper die 12 and the blade portion 32 of the Thomson blade 24 of the lower die 14 when the Thomson blades 24 were closest together was 0.1 mm.

For each fiber-reinforced resin plate 36, the fiber-reinforced resin plate 36 that was used was constituted of PA6, which is a polyamide-based thermoplastic resin, and glass fibers.

TABLE 1

| Plate thickness | | |
|---|---|---|
| of fiber-reinforced | Heating | Evaluation of |
| resin plate (mm) | temperature (° C.) | punching performance |
| t = 1.5 | Room temperature | C |
| | 57 | B |
| | 76 | A |
| | 90 | A |
| | 125 | A |
| | 175 | A |
| t = 2.0 | Room temperature | C |
| | 52 | A |
| | 70 | A |
| | 90 | A |
| | 120 | A |

According to Table 1, with plate thicknesses of 1.5 mm and 2.0 mm, the fiber-reinforced resin plate 36 could not be punched by the punching die 10 at room temperature in either case. In contrast, when the plate thickness of the fiber-reinforced resin plate 36 was 1.5 mm, the fiber-reinforced resin plate 36 could be punched by the punching die 10 at 57° C. or higher, and when the plate thickness was 2.0 mm, the fiber-reinforced resin plate 36 could be punched by the punching die 10 at 52° C. or higher. Thus, it was confirmed that punching of the fiber-reinforced resin plate 36 by the Thomson blades 24 was enabled by pre-heating of the fiber-reinforced resin plate 36.

—Punching Durability of the Thomson Blades—

Durability of the punching die 10 when punching was performed with the fiber-reinforced resin plates 36 at room temperature and with the fiber-reinforced resin plates 36 that had been pre-heated was investigated. The results are shown in Table 2 below.

For each fiber-reinforced resin plate 36, the fiber-reinforced resin plate 36 that was used was constituted of PA6, which is a polyamide-based thermoplastic resin, and glass fibers. The plate thickness of the fiber-reinforced resin plate 36 was 1.0 mm.

For the pre-heated fiber-reinforced resin plates 36, the temperature of the fiber-reinforced resin plates 36 was managed with an infrared radiation thermometer, with heating being re-applied by the infrared heater 38 when the temperature fell to 50° C. or lower.

TABLE 2

| Heating temperature (° C.) | Durability of punching die |
|---|---|
| Room temperature | Punching successful for 1800 shots |
| ≧50° C. | Punching successful even after 6000 shots |

According to Table 2, the punching die 10 was no longer able to punch after 1800 shots in the case in which the fiber-reinforced resin plates 36 were at room temperature. In contrast, the punching die 10 was still able to punch after 6000 shots in the case in which the fiber-reinforced resin plates 36 were at 50° C. or above. Thus, it was confirmed that the durability of the Thomson blades 24 was improved by pre-heating of the fiber-reinforced resin plates 36.

In the present exemplary embodiment, after the pre-heating of the fiber-reinforced resin plate 36 in the pre-heating step, the punching step is a step in which the fiber-reinforced resin plate 36 is punched to the predetermined external shape by the punching die 10 and the fiber-reinforced resin product 34 is formed. However, this is not limiting; the punching step may be two steps, including a pre-punching step. Specifically, two steps are applied to the fiber-reinforced resin plate 36 pre-heated in the pre-heating step: a step of forming cuts (incisions) or the like along the outline of the predetermined external shape with the punching die 10; and a step of punching to the predetermined shape with a press die. Accordingly, the fiber-reinforced resin plate 36 may be punched without applying a load to the punching die 10, particularly in a case in which the plate thickness of the fiber-reinforced resin plate 36 is large (for example, 2.0 mm or more).

In the present exemplary embodiment, the punching die 10 has the structure that is equipped with the Thomson blades 24, but this is not limiting. The punching die 10 may be structured with a forged blade, a cutter blade or the like. Furthermore, the punching die 10 has a two-blade structure, but this is not limiting. A one-blade structure in which the Thomson blade 24 is provided only at one or other of the upper die 12 and the lower die 14 is possible.

In the present exemplary embodiment, the fiber-reinforced resin plate 36 that is punched has a structure in which the reinforcing fiber fabric is glass fibers, but this is not limiting. The fiber-reinforced resin plate may have a structure in which the reinforcing fiber fabric is of an alternative fiber such as carbon fibers or the like.

Hereabove, an exemplary embodiment of the present invention has been described. The present invention is not limited by these descriptions, and it will be clear that numerous modifications outside of these descriptions may be embodied within a technical scope not departing from the spirit of the invention.

What is claimed is:

1. A method of punching a fiber-reinforced resin plate, the method comprising:
heating a fiber-reinforced resin plate, that is formed in a plate shape and is formed with a thermoplastic resin impregnated into a reinforcing fiber fabric, with a pre-heating section such that a surface temperature of the fiber-reinforced resin plate is at least a glass transition temperature of the thermoplastic resin; and
punching the heated fiber-reinforced resin plate to a predetermined external shape with a punching section that is provided with a Thomson blade.

2. The method according to claim 1, wherein the reinforcing fiber fabric of the fiber-reinforced resin plate includes continuous fibers rather than short fibers.

3. The method according to claim 1, wherein the reinforcing fiber fabric of the fiber-reinforced resin plate includes glass fibers.

4. The method according to claim 1, wherein the thermoplastic resin of the fiber-reinforced resin plate is a polyamide-based thermoplastic resin.

5. The method according to claim 1, wherein a plate thickness of the fiber-reinforced resin plate is at most 2.0 mm.

6. A method of fabricating a fiber-reinforced resin product, the method comprising:
heating a fiber-reinforced resin plate, that is formed in a plate shape and is formed with a thermoplastic resin impregnated into a reinforcing fiber fabric, with a pre-heating section such that a surface temperature of the fiber-reinforced resin plate is at least a glass transition temperature of the thermoplastic resin; and
punching the heated fiber-reinforced resin plate to a predetermined external shape with a punching section that is provided with a Thomson blade.
